(19) United States
(12) Patent Application Publication
(10) Pub. No.: US 2009/0307260 A1
(43) Pub. Date: Dec. 10, 2009

(54) System-of-Systems Knowledge Management System and Method of Operating the Same

(76) Inventors: Steven D. Roemerman, Highland Village, TX (US); Jerome Lee Krasner, Ashland, MA (US)

Correspondence Address: SLATER & MATSIL, L.L.P., 17950 PRESTON RD, SUITE 1000, DALLAS, TX, 75252-5793, US

(21) Appl. No.: 11/860,311

(22) Filed: Sep. 24, 2007

Related U.S. Application Data
(60) Provisional application No. 60/846,787, filed on Sep. 22, 2006.

(51) Int. Cl. G06F 9/44; G06F 17/30

(52) U.S. Cl. 707/103 R; 717/104; 707/E17.055

(57) ABSTRACT

A system-of-systems knowledge management (“SOSKM”) system employable with a system-of-systems and method of operating the same. In one embodiment, the SOSKM system includes an interface object module configured to create system interface objects from a plurality of disparate objects, thereby providing a loose coupling between systems of the system-of-systems. The SOSKM system also includes a wrapper module configured to encapsulate the system interface objects into a unified modeling language employable to manage the system-of-systems.

This application claims benefit of U.S. Provisional Application No. 60/846,787 entitled “Managing Systems Complexity as a Service Offering,” filed Sep. 22, 2006, which application is incorporated herein by reference.

### TECHNICAL FIELD

The present invention is directed, in general, to communication systems and, more specifically, to a system-of-systems knowledge management system and method of operating the same.

### BACKGROUND

Several large vertical markets have begun to adopt a “system-of-systems” approach to their missions. The ubiquity of networks, distributed data, and distributed sensors makes the system-of-systems both desirable and unavoidable. The missions served by the system-of-systems approach are diverse, yet have a similar set of problems. In total, about two trillion dollars a year are spent in a few vertical markets, which have adopted the system-of-systems. As the barriers to system-of-systems fall, the market for system-of-systems services will grow. There are critical unmet needs in system-of-systems management. There are important services to be offered to these markets, and the value of the services can be conservatively estimated at somewhere between 0.5 percent to three percent of the total dollars spent, or somewhere between 10 and 60 billion dollars. As will become more apparent, customers will enjoy a very large return on investment for the money spent in the system-of-systems services. This is not likely to be a price-sensitive opportunity and, properly positioned, a first mover may be able to achieve a 60 to 70 percent market share.

The most likely customers to employ a system-of-systems approach include organizations that operate very large, very complex systems and networks. In the United States, target customers may include the U.S. Department of Defense, National Aeronautics and Space Administration (“NASA”), American Telephone & Telegraph (“AT&T”), Verizon, and others. In Europe, target customers may include North Atlantic Treaty Organization (“NATO”), British Telecom (“BT”), Telecom Italia, the U.K. Ministry of Defense, the Italian Ministry of Defense, the German BdV, and the European Space Agency (“ESA”). In Asia, target customers may include Nippon Telegraph and Telephone, and the Japanese Ministry of Defense.

The target customers operate systems of staggering complexity. Elements of their mission infrastructure are major systems or subsystems in their own rights. For example, consider a large telecommunications switch, a communications satellite, or advanced aircraft radar: each is a complex system, yet each only has value in the context of other systems. These system-of-systems are growing in complexity and changing at slower rates. Some system elements outlive their designers. Consider aging telecommunication switches, the B-52 bomber, the 30 years it will take NASA and the ESA to go to Mars, and the older British naval vessels: all of these systems have three attributes; namely, the systems are system-of-systems, the systems have service lives of decades, and the systems employ systems architects to manage.

The population of systems architects is declining. As demonstrated with respect to FIG. 1, illustrated is a graphical representation of the U.S. aerospace professionals over time. The same or analogous trends are true for other system-of-systems. As the complexity and cost of systems has increased, the number of major new starts declines, and the number of learning cycles available for critical staff declines. In addition, the social contract that created long tenured technical experts has expired, and professionals no longer expect to be with an employer for decades. As a result, the costs and risks associated with managing system-of-systems over decades has become a major risk item in several vertical markets, and the impact of the risk is increasing.

The corporate response to this problem has been to push the risks downstream to customers. In the case of major telecommunication network operators, vendors have pushed this risk to the operators. In the case of aerospace systems, the prime contractors have pushed this risk to governments. To some extent, these customers have accepted these risks, and the related costs, in part, to enjoy the benefits of system-of-systems architecture and, in part, because there has been no alternative. In addition, customers have recognized that the costs associated with these issues are real, and have (in some cases) accepted the costs and risks to avoid the financial ruin of the supplier base.

The customers, however, are vulnerable to being taken advantage of by their suppliers and prime contractors, who have significant leverage. The system-of-systems operator has a number of risks and dependencies. The legacy of prior selections of technology, interfaces, standards, contractors, and other choices create a powerful incumbency. It can be very difficult to update a system-of-systems without the cooperation of the incumbent or legacy sources.

In telecommunications, this can be seen in terms of the difficulty of integrating a new system, such as a smart antenna, into existing infrastructure (e.g., base stations). While it is possible to replace a simple component such as a simple antenna, complex systems with dynamic interfaces and control logic are daunting. This same problem is seen in the integration of new avionics or weapons with a military aircraft. In both cases, the incumbent (e.g., the base station vendor or aircraft prime contractor) can block nearly any customer action. In addition, the customer may find it nearly impossible to understand the pricing and costing of integration, even in those cases wherein the cooperation with the legacy provider is good.

As a result, few smart antennas have ever been added to wireless infrastructure, and the cost of integrating a weapon can exceed the cost of developing and producing the weapon. These, of course, are but a few examples of the difficulties of managing complex systems. Many additional examples can be identified in the telecommunications marketplace. Some of the more extreme examples that will present themselves over the coming years are increasing integration complexity with operational support systems (“OSS”) and billing support systems (“BSS”), the introduction and integration of Internet protocol (“IP”) multimedia subsystems (“IMS”) into the core networks of many operators, the rollout of Internet protocol television (“IPTV”) and the eventual introduction and proliferation of peer-to-peer interaction in wireless and other communication networks.

As the life span and complexity of system-of-systems has increased, the costs of managing them have become very significant. As an exemplary result, the Boeing Corporation has enjoyed far more revenue from the management of the B-52 fleet than from the original procurement of the aircraft. The B-52 is not an isolated case. The same pattern is found in, for instance, air defense systems, in cable set top boxes, and telecommunication networks.

The B-52 and a number of aircraft are equipped with the MIL STD-1553 data bus as illustrated in a block diagram of FIG. 2. The original intent of the data bus was to allow upgrades to military platforms such as aircraft and ships. The hope was that a flexible data bus would allow the simple addition of new sensors and processors. To some extent, that original vision has been realized. However, only the vendors of the devices attached to the data bus have faced competitive pressures from the “plug and play” promises of MIL STD-1553, which is incorporated herein by reference. The system prime contractors have maintained monopoly control. This has happened, in part, due to the additional complexity that data exchanges, standards, protocols, and data buses allow.

In enterprise and telecommunication networks, the migration from signaling system #7 (“SS7”) to Internet protocol versions 4 and 6 (“IPv4” and “IPv6”), which are incorporated herein by reference, has followed a similar path. The myriad of network connection, management, and permission options of a packet environment (as well as the fact that all IP terminals have far more authority that the plain old telephone service (“POTS”) handset had in an SS7 circuit switched context), create a nightmare of complexity for network operators. The paradox of simple interface standards is that the standards tend to create closed systems favoring original equipment manufacturers (“OEMs”).

In a few cases, the original vendor has found it to be advantageous to have an open architecture, or open interfaces. An example is the gaming business. Vendors make it practical for third party developers to provide games and, thus, have a richer experience to offer potential customers. In some cases, interfaces are clearly open and, in other cases, the degree of openness is debatable.

In the case of weapon-to-launch platform integration, the result of “open interfaces” has been problematic. As an example, FIG. 3 illustrates a view of a MIL STD-1760, which specifies a wide range of interface topics, including wiring standards, data bus standards, data bus protocol, connector types, and many other features. The exemplary interfaces controlled by the standard include the aircraft station interface (“ASI”), the carriage store interface (“CSI”), the carriage store station interface (“CSSI”), and the mission store interface (“MSI”). In spite of several years of work, this standard has failed to produce an opportunity for a weapon of any significant complexity to be successfully mated to a launch platform, without a very significant outlay of funds to the platform prime contractor. As a result, the U.S. Air Force (“USAF”) has introduced the concept of the “universal aircraft interface” that features management of the data objects. While this approach will surely result in a reduction of integration costs, it will not threaten the grip of aircraft prime contractors.

In a similar vein, the connection of a wireless base station to a base station controller is almost universally the domain of the base station vendor. A hybrid system including a base station from one vendor and a controller from another vendor is very rare. Even the interface between the controller and the network switch can be highly proprietary (in spite of “compliance with standards”). As an example, nearly all Motorola base stations and base station controllers use an Alcatel switch resulting in an alliance between Motorola and Digital Switch Corporation (“DSC”), prior to the acquisition of DSC by Alcatel. The Alcatel decisions about this business, and merging with Lucent, a traditional competitor of Motorola's wireless infrastructure product line, are problematic for operators of Motorola equipment, and for Motorola. The MIL STD-1760, which is incorporated herein by reference, and the Motorola examples are far from unique, but represent the challenges that come with the ownership and operation of system-of-systems.

What is needed in the art is a system and method for the operators of system-of-systems to make choices about the degree to which their architectures are open. Moreover, what is needed is a system and method that makes choices possible years or even decades after deployment, but with benefits for operators who take action at the time of purchasing systems and upgrades.

### SUMMARY OF THE INVENTION

These and other problems are generally solved or circumvented, and technical advantages are generally achieved, by advantageous embodiments of the present invention, which includes a system-of-systems knowledge management (“SOSKM”) system employable with a system-of-systems and method of operating the same. In one embodiment, the SOSKM system includes an interface object module configured to create system interface objects from a plurality of disparate objects, thereby providing a loose coupling and cohesion between systems of the system-of-systems. In an exemplary embodiment, the plurality of disparate objects may be selected from a hardware model, software model, database object, and process models associated with a system of the system-of-systems. Additionally, one of the system interface objects may be produced by modifying another one of the system interface objects, and one of the system interface objects may be provided in accordance with modules from ones of core technology providers, supporting technology providers and trusted advisors. The SOSKM system also includes a wrapper module configured to encapsulate the system interface objects into a unified modeling language employable to manage the system-of-systems. The wrapper module may also generate test vectors to perform integrity checks in accordance with the system interface objects. The SOSKM system may also include a database configured to archive the system interface objects.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a graphical representation of U.S. aerospace professionals over time;

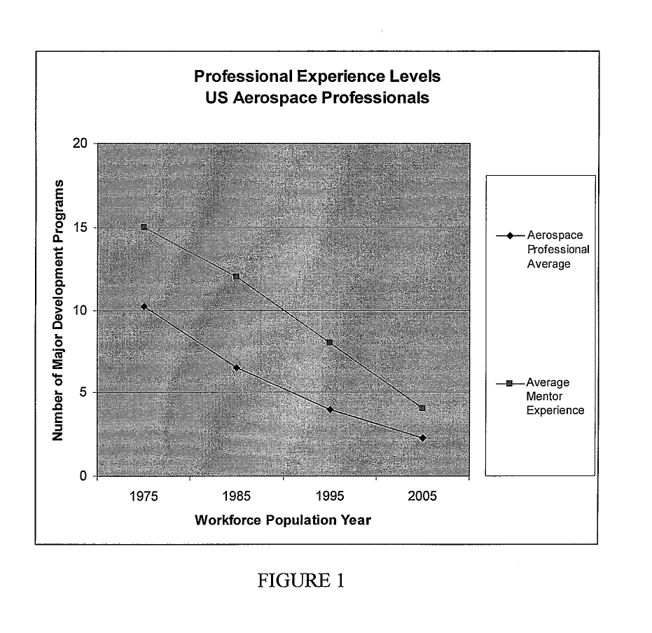

FIG. 2 illustrates a block diagram of a MIL STD-1553 data bus employable with aircraft including a B-52;

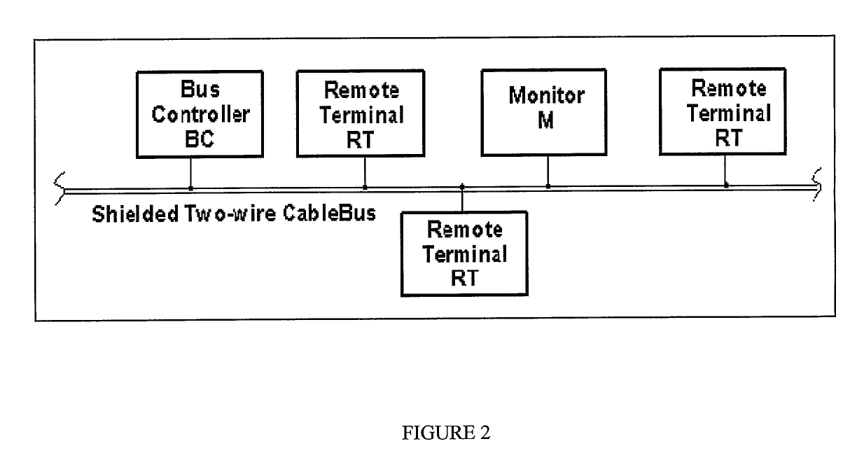

FIG. 3 illustrates a view of a MIL STD-1760 that specifies a wide range of interface topics including wiring standards, data bus standards, data bus protocol and connector types for aircraft;

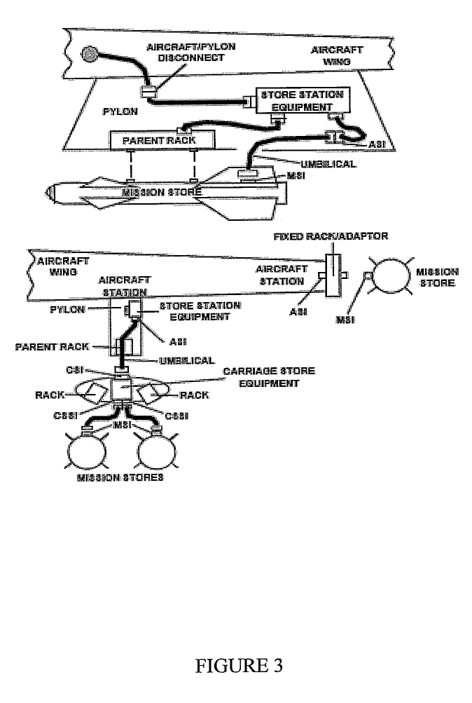

FIG. 4 illustrates a block diagram of an embodiment of a computer system that provides an environment for a SOSKM system according to the principles of the present invention;

FIG. 5 illustrates a block diagram of portions of an embodiment of a SOSKM system according to the principles of the present invention;

FIG. 6 illustrates a diagram of exemplary system interface objects combined to emulate a system-of-systems according to the principles of the present invention;

FIG. 7 illustrates a diagram of an embodiment of a core technology provider cooperating with supporting technology providers in accordance with the principles of the SOSKM system of the present invention; and

FIG. 8 illustrates a diagram that demonstrates how a core technology provider works with a trusted advisor to serve various system-of-systems users in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

A general class of solutions enabling the objectives as set forth above includes a system-of-systems knowledge management (“SOSKM”) system. The SOSKM system includes engines that can mine, understand, sort, classify, and retrieve information (e.g., Engenium's Semetric, various crawlers, Google products, and many others), modules that permit oversight of knowledge and commercial exchange (e.g., fuzzy logic and rule based supervisors, monitors, alarms, etc.), archival subsystems, configuration management modules, and requirements management modules (e.g., DOORS by Telelogic, Caliber by Caliber Management Systems, and the hierarchical verification environment (“HiVe”), a project under development by the TCS Group at Defense Science and Technology Organization). Other subsystems that may be included in the SOSKM system include a collection of precuts and tools that enforce protection of valuable or sensitive knowledge.

The current generation of solutions does not fully address the problem of managing the life cycle for system-of-systems. The main problem vexing users of existing solutions is the need for human architects with extensive experience, corporate memory, and domain expertise. As we have already demonstrated, the system-of-systems operator cannot expect to have an adequate staff of such individuals. Therefore, automation of object oriented design paradigms is an enabling technology that extends the SOSKM systems to a new level.

Since the introduction of object oriented design over 30 years ago, technologists have yet to fully exploit the implications of concepts such as abstraction and inheritance. One current manifestation of these ideas is the unified modeling language (“UML”). The unified modeling language was conceived as a technique for specifying, visualizing, constructing, and documenting the artifacts of software systems, but has grown to support business modeling, modeling of complex hardware systems, and other non-software systems. The SOSKM system may employ an advanced version of the unified modeling language with other subsystems as described herein for addressing system-of-systems challenges.

Extending object oriented processes and paradigms beyond the realm of the present environment may be supported by advanced unified modeling language toolsets and processes. In particular, a feature known as “encapsulation” is powerful when applied to the SOSKM system, rather than merely to software as its original proponents envisioned. When properly implemented, encapsulation exposes enough of a subsystem to allow other system elements to make use thereof. Object-oriented unified modeling language rule sets allow for a user to specify the degree of visibility of elements of the subsystem, so access by client code or client subsystems is restricted. Thus, one can syntactically seal off implementation details, leading to flexibility and maintainability of the larger system. Encapsulation, in turn, promotes two other seemingly contradictory features (or paradigms), namely, loose coupling and strong cohesion. These terms may not be familiar to all system-of-systems operators, but these concepts are embraced as goals for system-of-systems owners and operators.

Loose coupling refers to the ways in which, and degrees to which, one part of the system relies on the details of another part. The tighter the coupling, the more changes in one part of the system affect and impact other components and operations throughout the system. With loose coupling, the interfaces between subsystems are well defined and restricted. What lies beyond the interfaces can change without any changes needed in the client subsystems. Object oriented programming supports loose coupling by allowing designers to define and publish a class' methods without publishing how those methods are carried out. This, in turn, allows for “hostile” parties to have limited access to interfaces, by revealing only the interface information needed. So, loose coupling is particularly valuable in system-of-systems with multiple levels of access, security, and sensitivity.

A feature of new unified modeling language tools is to encapsulate legacy systems. In the unified modeling language sense, this involves capturing and abstracting baselines of new designs described in unified modeling language, and performing these same actions for legacy designs. Whether applied to a new design, or to a legacy system, an objective of the SOSKM system is to define the attributes of a systems interface so as to provide both encapsulation and loose coupling, and to achieve this in a way that may not map to a product from a single vendor. This involves creating a “wrapper” so that the encapsulated system element, as represented in a tool such as unified modeling language, along with the additional features and archival knowledge of the wrapper, result in an encapsulated object with much more robust SOSKM system features than would otherwise be possible.

This idea of using a wrapper, along with a functioning system element, to create a SOSKM system encapsulated object is very powerful. It has the benefit of creating loose coupling where none existed before. For example, in video on demand, the billing system interface object may involve physical objects (e.g., servers and set top box) that are widely separated and processes (e.g., order confirmation and video streaming) that are also disparate. Assuming that the system interface object is the billing objects between the customer and the billing system, however, the system interface object incorporates elements from a number of disparate objects (e.g., items or features).

When “work arounds” in system-of-systems are used by designers, one frequently finds that loose coupling has been created where none was intended, or when a vendor had hoped to prevent it, for the sake of future profits. In the case of weapon-to-platform integration, a common tactic is to ‘trick’ the launch platform system into thinking it is dealing with a legacy weapon system (e.g., Maverick or Walleye) and in the case of telecommunications, the use of combinations of IPv4 features and SS7 features, to spoof network elements and achieve desired operation of legacy elements in ways the creators never imagined, are well known. Thus, manual efforts to achieve loose coupling are wide spread. Manual efforts, however, require the use of talent that is in short supply, and manual efforts rarely result in a solution that is directly useful as an object within an object oriented framework.

The wrapper provides a tool for a fully compliant object oriented solution. Moreover, the automatic extraction and extension of the features of an element or object to archive and manage loose coupling is beneficial. This means that the construction of the wrapper can be automated, or partly automated. Examples of automatic extraction and conversion are plentiful. Examples include Xalan (which automates the conversion of extensible markup language (“XML”) objects to other kinds of objects) and Microsoft's object linking and embedding (“OLE”) approach to linking document types from different applications by embedding a link to the document of another application within a document. Domino extensible language (“DXL”) is another relevant example of an automation technique with application programming interface (“API”) like features, but also with some object oriented attributes promoting loose coupling. System modeling language (“SYSML”) is yet another example that provides the aforementioned features.

Automatic extraction is a powerful feature of modern tool sets. This class of tools permits importing design elements or objects that were not developed with model based tools, and were not conceived with object oriented principles. These tools can provide detailed listings of interfaces, map the interaction of system elements or objects, extract embedded documentation, and provide other functions, useful to the creation of the wrapper.

The wrapper is applicable, even without automatic extraction. The wrapper provides a tool to manage system-of-systems in an automated way, and promotes the maintenance and growth of systems functions, even in the context of new vendors, or the loss of an old vendor. By using these tools to extract critical information, it is practical to construct the elements of the wrapper, and to do so without deep domain expertise, and without the help of the original system architect. Thus, the SOSKM system extends the principles of automatic extraction to create a powerful tool.

The benefits of the SOSKM system and the idea of automation promoting loose coupling will be described in the contest of the following examples relating to fax modems and matrix laboratory (“MATLAB”) products. In the case of hardware automation resulting in loose coupling, most fax modems automatically adjust to a wide range of telecommunication network standards and modem standards. Thus, a V.92 modem in a fax machine can send full color faxes to another advanced fax machine at a high transfer rate, and send a black and white fax to a V.22 modem, at the lower speed of that interface. Moreover, the sender can be in Germany and send to a user in the United States on a plain old telephone service network, to a user in Japan with an e-fax account, or to a user in Brazil using an IP phone connected to a fax machine.

Another example of automation resulting in loose coupling is the use of MATLAB products to model the operation of both the hardware and software elements of a system. The tools are capable of automatically generating the source code (e.g., C+code) and the circuit descriptors for a field programmable gate array (“FPGA”). Thus, the model can specify both the hardware and software realization of a design. If, at some point in the future, the FPGA needs to be converted to an application specific integrated circuit (“ASIC”), or if the source code language needs to be changed, this can be done without modification of the design. Moreover, the model can be used with hardware in the loop testing to validate the hardware, and these tests can be repeated if a software supplier or hardware vendor is changed. This is an example that demonstrates that the concept of loose coupling can be applied to both hardware and software system elements.

So, from these examples, it can be demonstrated that the use of automatic tools, including modeling tools, has reached a level of maturity that is useful in providing loose coupling among system elements and, therefore, it should be clearer that construction of the wrapper can be an automated or largely automated process. This makes the teaching of the wrapper, as described herein, very powerful.

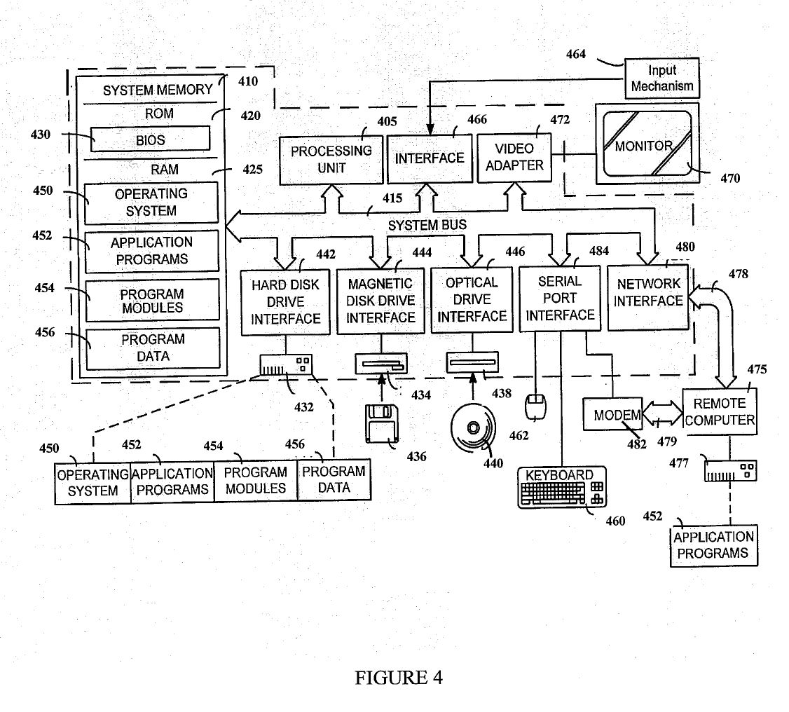

Turning now to FIG. 4, illustrated is a block diagram of an embodiment of a computer system that provides an environment for a SOSKM system according to the principles of the present invention. While the present invention is not limited thereto, the computer system is a personal computer (“PC”). Additionally, the SOSKM system including the subsystems and modules thereof may be embodied in hardware, software including program modules, and combinations thereof. Generally, program modules include routines, programs, objects, components, data structures, etc. that perform particular tasks or implement particular abstract data types. Moreover, those skilled in the art will appreciate that the SOSKM system may be practiced with other computer system configurations including handheld devices, multiprocessor systems, microprocessor based or programmable consumer electronics, network PCs, minicomputers, mainframe computers, and the like. The SOSKM system may also be practiced in distributed computing environments where tasks are performed by remote processing devices that are linked through a communications network. In a distributed computing environment, program modules may be located in both local and remote memory storage devices.

As shown, the computer system includes a processing unit 405, a system memory 410, and a system bus 415. The system bus 415 links together various system components including the system memory 410 and the processing unit 405. The system bus 415 may be any of several types of bus structures including a memory bus or memory controller, a peripheral bus, and a local bus using any of a variety of bus architectures. The system memory 410 typically includes read only memory (“ROM”) 420 and random access memory (“RAM”) 425. A basic input/output system 430 (“BIOS”), containing the basic routine that helps to transfer information between elements within the computer system, such as during startup, is stored in the ROM 420.

The computer system further includes a hard disk drive 432 for reading from and writing to a hard disk, not shown, a magnetic disk drive 434 for reading from or writing to a removable magnetic disk 436, and an optical disk drive 438 for reading from or writing to a removable optical disk 440 such as a CD ROM or other optical media. The hard disk drive 432, magnetic disk drive 434, and optical disk drive 438 are connected to the system bus 415 by a hard disk drive interface 442, a magnetic disk drive interface 444, and an optical drive interface 446, respectively. These drives and their associated computer readable media provide nonvolatile storage of computer readable instructions, data structures, computer programs and other data for the computer system.

A number of computer programs may be stored on the hard disk, magnetic disk 436, optical disk 440, ROM 420 or RAM 425, including an operating system 450, one or more application programs 452, other programs 454, and program data 456. A user may enter commands and information into the computer system through various input devices such as a keyboard 460 and pointing device 462 (such as a mouse, etc.). An additional input mechanism(s) 464 can also be included via an appropriate interface 466. As shown, a monitor 470 or other type of display device is also connected to the system bus 415 via an interface, such as a video adapter 472. In addition to the monitor 470, the computer system may also include other peripheral output devices (not shown), such as speakers, printers, etc.

The computer system may operate in a networked environment using logical connections to one or more remote computers, such as a remote computer 475. The remote computer 475 may be another personal computer, a server, a router, a network PC, a peer device or other common network node, and typically includes many or all of the elements described above relative to the computer system, although only a memory storage device 477 has been illustrated in FIG. 4.

The logical connections depicted in FIG. 4 include a local area network (“LAN”) 478 and a wide area network (“WAN”) 479. Such networking environments are commonplace in offices, enterprise wide computer networks, Intranets and the Internet. When used in a LAN networking environment, the computer system is connected to the local area network 478 through a network interface or adapter 480. When used in a WAN networking environment, the computer system typically includes a modem 482 or other means for establishing communications over the wide area network 479, such as the Internet. The modem 482, which may be internal or external, is connected to the system bus 415 via a serial port interface 484.

In a networked environment, computer programs depicted relative to the computer system, or portions thereof, may be stored in the remote memory storage device. It will be appreciated that the network connections shown are exemplary and that other means of establishing a communications link between the computers may be used.

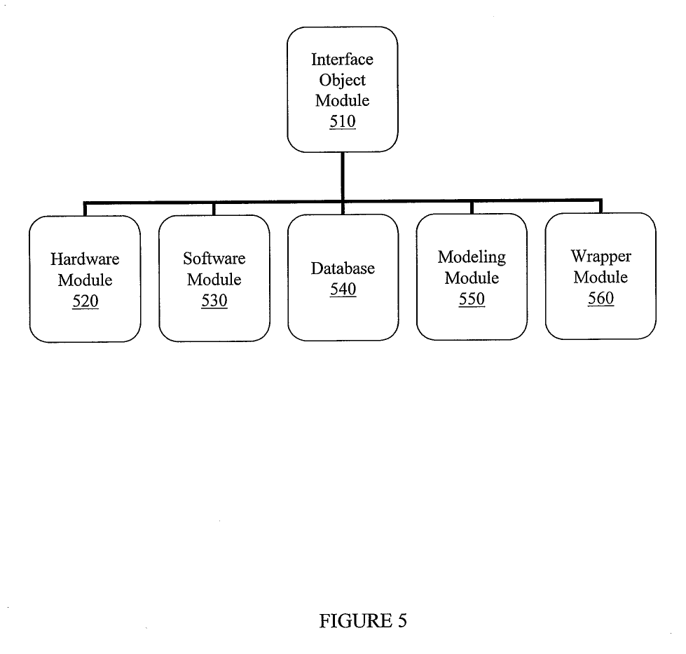

Turning now to FIG. 5, illustrated is a block diagram of portions of an embodiment of a SOSKM system according to the principles of the present invention. The SOSKM system includes interface object module 510, a hardware module 520, a software module 530, a database 540, a modeling module 550 and a wrapper module 560. The hardware module 520 provides captured hardware models of the system-of-systems. The software module 530 provides captured software objects (e.g., software source code) of the system-of-systems. The database 540 provides database objects of the system-of-systems such as allowed system states, commands and related characteristics. The modeling module 550 provides process models of processes operating within the system-of-systems. The wrapper module 560, as described above, encapsulates system interface objects into a unified modeling language employable to manage the system-of-systems. The wrapper module 560 can also provide additional modeling that generates test vectors to perform health or integrity checks in accordance with the system interface objects, and other model elements for the system interface objects.

The interface object module 510 is adapted to take an object, and by combining it properly with other disparate objects, create an entirely new class of system interface objects. Thus, the interface object module 510 creates system interface objects from a plurality of disparate objects, thereby providing a loose coupling between the systems of the system-of-systems. The unified modeling language provides a mechanism to automate the process. For instance, the use of unified modeling language (or unified modeling language-like) encapsulation, using feature extraction, extension and the use of wrappers, may simplify and automate processes, techniques, and objects to achieve loose coupling among the elements under the SOSKM system. To draw a comparison, if a class of objects called leaves is combined with objects of the classes of twigs, branches, and roots, a new class of system interface objects called bushes is defined.

The system interface object provided by the interface object module 510 may be composed of a number of lower level objects, such as database objects, software objects, hardware models, and other objects. The system interface object includes a wrapper and provides a mechanism for the SOSKM system for archival integrity via the database 540 and for reuse of the system interface object in future applications, with loose coupling. The system interface object is much more than an interface control document, which is a static representation of the interface, and more than the hardware and/or software that make up a classical interface module. These objects do not fully embody the functions of the interface object module 510 in the context of the system-of-systems. For a complex application of the SOSKM system, the system interface object will include a number of features absent in the interface control document or classical interface module. These absent features may include test vectors, health checks, and many other aspects of systems operation or systems integrity that are neither needed nor present in the well documented interface control document or classical interface module. The system interface object is a much more powerful paradigm and process than its predecessors, and by virtue of object oriented principles, such as inheritance (and other conventional features), the system interface object can be extended far beyond its original designer's intent or comprehension.

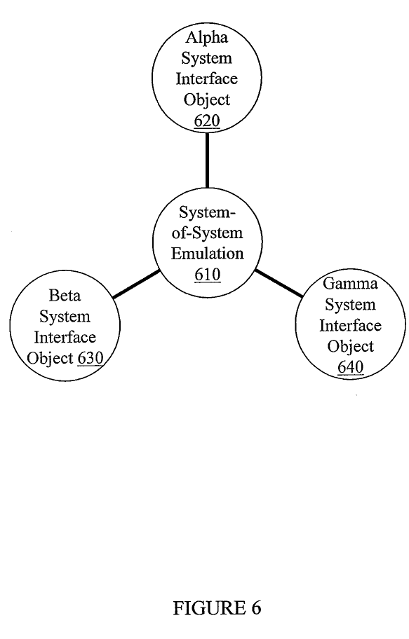

Turning now to FIG. 6, illustrated is a diagram of exemplary system interface objects combined to emulate a system-of-systems according to the principles of the present invention. A system-of-systems emulation 610 is performed in accordance with an alpha system interface object 620, a beta system interface object 630 and a gamma system interface object 640. The gamma system interface object 640 is produced by modifying the alpha system interface object 610.

The unified modeling language tools, and the other tools described above, provide exemplary technological techniques to create, maintain, and extend the useful life of system interface objects. The proper application of the unified modeling language and related tools, used to create the system interface objects, results in a new object that can be used to create new system interface objects, with the ease of an application programming interface, even if the system interface objects defies the normal requirements for creating an application programming interface. The system interface object may contain elements or objects taken from more than one location in the system-of-systems. The system interface object may represent the work product of several different vendors and may represent accurately dynamic behavior, not merely a static description, or very simple dynamic operation as is common to many interface control documents. Unlike “interface stereotypes” used in some unified modeling language and object oriented design methods, the system interface object described herein provides both inheritance and extension.

Thus, the system interface object is more useful, and much more powerful, than any of the concepts, paradigms, and teachings that preceded it. The system interface object is a tool for a system-of-systems operator to achieve loose coupling by employing the work products of a number of contributors, including some that may no longer be available, some that may not willingly cooperate, and some that are simply too expensive to use. This loose coupling is achieved without the sacrifice of strong cohesion when the SOSKM system is successful. Cohesion refers to the degree in which elements within a system form unified concepts, with little or no excess elements. As originally proposed by object oriented advocates and programmers, cohesion represented the extent to which a system composed of objects represented a single, unified concept. For the purposes as described herein, a slightly different view is preferable.

For instance, the telecommunications network is, at the same time, a number of very different networks, including a plain old telephone service network, an IPv4 network, a mobile network, a long distance network, and so on. A nuclear submarine is, at the same time, a nuclear deterrent, an intelligence collection asset, a special operations team insertion tool, and other things. Thus, for the complex system-of-systems, the idea of strong cohesion may be extended to the unified concepts represented by the system-of-systems. This seems to be a daunting requirement since system-of-systems can be extended and merged with one another to create new unified concepts that were never envisioned during their creation. For example, the plain old telephone service wiring, common in most homes, was never envisioned as a means to deliver high bandwidth communication, but today, the same wires in many homes deliver both plain old telephone service and digital subscriber line service. Another example is found with the B-52, today used to deliver global positioning systems guided weapons often for close air support, a role that would have befuddled the original designers who intended it to deliver nuclear weapons.

Where there is strong cohesion, there is easier comprehension and thus more reliable systems. For example, strong cohesion among the navigation elements of a ship or an aircraft can result in a very high degree of reliability, redundancy, and performance. There are several sets of gyros aboard a ship or airplane, and there may be both inertial navigators and global positioning systems. The appropriate use of information from these various systems can result in performance far exceeding the capability of any single system. The inappropriate use of information, however, can be catastrophic. Using bad global positioning system fixes to align an otherwise healthy inertial navigator, will result in a total loss of navigational accuracy.

Similarly, when a network router obeys proper protocol, the result in most cases is that packets of information arrive with reliability that far exceeds the reliability of the transport elements. In some wireless networks, however, the very features within a router's use of IPv4 or IPv6 compatible subsystems, which are intended to provide the confidence that a packet will arrive, can overload a low bandwidth wireless system with status checks and re-transmit requests, causing a total network failure unless the router is ‘spoofed’ by systems that protect the wireless network. As an example, consider the system interface object that a network operator may commission for an IPTV set top box. The system interface object may incorporate the knowledge of how to access many different systems and different physical and logical locations in the network including unicast and multicast servers, video-on-demand servers, and network based trick play servers. These servers and their corresponding software will potentially be provided by many different vendors including Alcatel, Hewlett Packard, International Business Machines, Microsoft and others.

In fact, a system interface object for an IPTV application might include a number of system interface objects that are focused on different facets of the IPTV system-of-systems. The SOSKM system and process would manage these system interface objects and their relationships, such that unintended consequences are avoided, and so that, like the integrated navigator, video services can be offered that seem to exceed the capability of any single system, and the network operator will not be held hostage to a single vendor to supply any one portion of the system-of-systems.

It should be clear that the creation of system interface objects from other objects provides an unlimited number of abstractions, and thereby promotes loose coupling that might otherwise be impossible to achieve. It should also become understood, in the context of object oriented paradigms, that the resultant system interface objects created can have attributes, functions, and features that were never envisioned by the designers of the predecessor objects.

It should also be clear to those skilled in the art of knowledge management and unified modeling language representations, that some degree of human intervention may be necessary, in some cases, both to encapsulate and archive system interface objects, and to repurpose them. The system interface objects can be used for documentation, for archival purposes, for simulation, for vendor management, for management of technology obsolesce, for system level modeling and performance prediction, and for many other useful purposes valuable to those engaged in the art of system-of-systems.

In the IPTV example, the architects and business planners for the network operator can anticipate the various and final network elements that may be combined to create the system interface objects. Once selected and created, however, the system interface objects can provide an application programming interface-like subsystem to extend the performance, features, and product offerings of the network operator. It should become clear to those skilled in the art that similar examples exist in other system-of-systems, such as across the sensor-to-shooter kill chain, the U.S. Department of Defense global information grid (“GIG”), corporate virtual private networks (“VPNs”), and other system-of-systems.

The solution, in some cases, employs the collaboration of a number of organizations, independent of the owner-operators that employ a SOSKM system. In most of the interesting cases of system-of-systems knowledge management, the collaboration spans several levels of the value chain, including more than one system-of-systems operator, and many suppliers in a number of nations. Thus, other business processes and structures may be employed with the technology solutions described herein.

In the case of telecommunications, collaboration has been needed and, at the same time, can be problematic. Many system-of-systems cross the boundaries of a given network. This was the original motivation for signaling system #7. Early telephone networks in developed nations were the result of years of evolution, with simple interfaces between networks, human operators, limited capacity, moderate user expectations, and little thought about future technology.

Based around analog equipment, the telephone network of the early telephone company was not well suited for automated management, had problems with collection of service revenues across operators, and had little or no planning for services such as data and video. Many individual technology service providers emerged in the 1960s and 1970s, providing packet-switching network and data communications services that national telephone companies were not equipped to provide.

The international telephone network faced similar problems and, in some cases, much worse problems. In nations with poor telecommunications infrastructure, the lack of an evolutionary history was a blessing (no burden of old analog gear) and a curse (no clear direction forward). International bodies began investigating technologies for providing telephone service for businesses (such as direct dialed international long distance) to the masses (eventually including new network types such as cellular networks). These same bodies considered the needs of network operators with extensive, but aging, capital investments, and the needs of operators who lacked significant existing infrastructure. The International Telecommunications Union (“ITU”) commissioned a study on the possibility of an all-digital intelligent network. The result was a series of standards known now as signaling system #7 (“SS7”).

These standards have paved the way for the intelligent network (“IN”) and, with it, a variety of services, many yet to be unveiled. Signaling system #7 has evolved to a series of American National Standards Institute (“ANSI”) standards, controlled the by ITU, through standards bodies drawn from a number of governments and corporations. The aforementioned standards body approach has both positive and negative lessons learned.

From a positive standpoint, all of the major network operators support signaling system #7 and the costs of its management, because it is a clear opportunity to offer services, and to broaden the supplier base. Both AT&T and Nippon Telegraph and Telephone enjoy some common vendors at more than one layer of the value chain and both firms can offer international long distance services that are reliable and easy to use, at lower costs and higher profits than would be possible without signaling system #7. Companies such as France Telecom and BT can cooperate without fear of anti-trust concerns, by virtue of the neutral cooperation opportunity provided by the ITU.

As service offerings and networks have evolved to a more IP centric perspective, signaling system #7 will eventually give way to an IP based system-of-systems. This system-of-systems will be based on the IP multimedia subsystem (“IMS”) standard created by Third Generation Partnership Program (“3GPP”). Through session initiation protocol (“SIP”), H.323 protocols and other protocols, carriers will be able to provide basic and advanced IP services. These services will be enabled through standardized devices such as the home subscriber server (“HSS”) and call session control function (“CSCF”).

Like signaling system #7, IP multimedia subsystem has its challenges with regard to integration and interoperability. One example of this is SIP extensions, which are designed to facilitate the creation and utilization of services and functionality. These extensions should either be the same, or have been translated appropriately, for services to work properly between devices and networks. While the IMS standards are an excellent starting point, extensions are not sufficiently defined, creating a need for a SOSKM system as described herein. Similar historical examples can be cited in the creation of IEEE standards used by a number of industries, and military standards, such as MIL-STD-1533, 1760 and other military standards that are used by defense organizations in many nations.

Thus, collaboration among would-be rivals in a neutral setting is important to successful system-of-systems knowledge management and to extending existing system-of-systems for new purposes. The collaboration is also necessary to promote competition among the suppliers of system elements in a way that is acceptable to anti-trust regulators. The collaboration should not be used as a mechanism to promote stealthy introduction of proprietary methodologies, which has been the bane of standards bodies. Particularly important, given the long life of telecommunication capital assets, was the involvement of the ITU and IEEE. The participants needed a forum hosted by organizations whose longevity was not in question. When these goals are met, history shows that highly useful organizational solutions have been achieved. The SOSKM system describes a system and methodology that meet these goals.

Unified modeling language supporters claim it represents a collection of best practices that have proven successful in the modeling of large and complex systems. The unified modeling language provides graphical notations to express the design and system functions. The unified modeling language was not the first attempt at such a means. For instance, by the late 1980s, there were several different approaches to object oriented analysis and design. The number of identified modeling languages increased to more than 50 by 1994. By the mid 1990s, convergence of some methods was clear as leading proponents began to incorporate each other's techniques, and a few clearly prominent methods emerged, leading to the concept which became known as the unified modeling language. The development of the unified modeling language began in 1994 when Grady Booch and Jim Rumbaugh of Rational Software Corporation began to unify the Booch and object modeling technique (“OMT”) methods. In 1995, Ivar Jacobson and his Objectory Company joined the Rational Software Corporation, merging in the object oriented software engineering (“OOSE”) method.

The collaboration of Booch, Rumbaugh, and Jacobson led to the release of the unified modeling language version 0.9 in June 1996. During 1996, it became clear that several organizations saw the unified modeling language as strategic to their business. The Rational Software Corporation established the unified modeling language partners consortium with several organizations willing to dedicate resources to work toward a strong unified modeling language version 1.0 definition. Those contributing most to the unified modeling language version 1.0 definition included the Digital Equipment Corp., Hewlett Packard, I-Logix, IntelliCorp, International Business Machines, ICON Computing, MCI Systemhouse, Microsoft, Oracle, Rational Software Corporation, Texas Instruments, and Unisys. This collaboration produced the unified modeling language version 1.0 definition, a modeling language that was well defined, expressive, powerful, and generally applicable. Since that time, both the Rational Software Corporation and i-Logix have been acquired by International Business Machines and Telelogic, respectively, and unified modeling language version 2.0 has become well established, with some version 2.0 products released though multiple product generations. The aforementioned versions of the unified modeling language and other standards provided herein are incorporated herein by reference.

Unforeseen, the collaboration has also led to the emergence of a new definition of object oriented systems engineering, which includes far more than just software. This extension is applicable to the technical concepts and processes described herein. Inasmuch as the extension of object oriented concepts and model based representations of designs and systems have penetrated deeply into systems engineering paradigms (e.g., SYSML), this is a topic familiar to those skilled in the art. Using the object oriented paradigms for systems with collaboration is a powerful part of the process associated with the SOSKM system that can be successful. Thus, the development of the unified modeling language tool set employed the collaboration of a number of firms, in a number of industries. Collaboration among would-be rivals, and among firms from different parts of the value chain, in a neutral setting is important to successful system-of-systems knowledge management tool set definition and adoption. This, in turn, results in extending existing object oriented paradigms beyond the concepts of their creators.

The collaboration was also necessary to promote a common technology adoption across the many levels of the value chain providing system elements. The collaboration needed to be established in a way acceptable to the principle corporate participants. Particularly important was the participation of technology leaders across the value chain, and in the central areas. Due to the rapid changes in technology, it was important to have both broad representation (e.g., computer providers, software providers, chip providers, system integrators, networks operators) and subject matter experts with deep domain expertise. Due to the powerful collaboration, the nature of the unified modeling language proved to be far more generic, serving mechanical modeling, and other uses, which many of the participants never expected. The near term usefulness was cause in part by this diversity, and the longer term broad appeal was driven in part by the diverse participation.

An example of structure and processes proposed with the SOSKM system would be the creation of a core technology provider (“CTP”), supported by “best of breed” firms. The relationship between the core technology provider and supporting technology providers (“STPs”) could vary, depending on business needs of the organizations. The core technology provider integrates offerings, tools, and services of supporting technology providers.

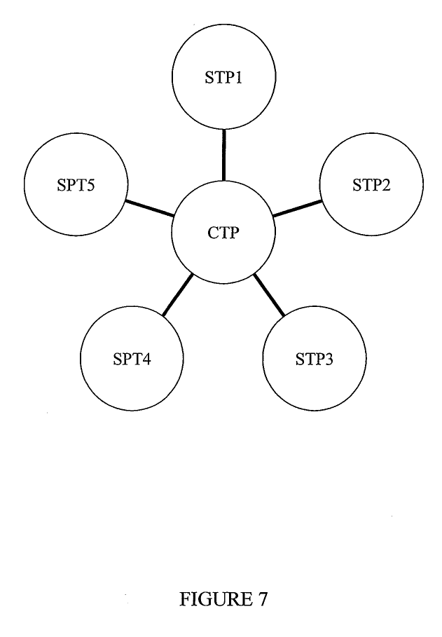

Turning now to FIG. 7, illustrated is a diagram of an embodiment of a core technology provider (designated “CTP”) cooperating with supporting technology providers (designated “STP”) in accordance with the principles of the SOSKM system of the present invention. The first supporting technology provider STP1 is a unified modeling language tool provider, the second supporting technology provider STP2 is a knowledge management tool provider, the third supporting technology provider STP3 is a search/crawl tool provider, the fourth supporting technology provider STP4 is a telecommunications network tool provider, and the fifth supporting technology provider STP5 is a defense system-of-systems tool provider. While the supporting technology providers are referred to as providers, the diagram may represent modules provided by the respective supporting technology providers. The same principle applies to the core technology provider and the trusted advisors as set forth below. Additionally, the number of supporting technology providers may change over time, as the number of underlying tools supporting system-of-systems knowledge management changes, and as the industry verticals that employ the system-of-systems knowledge management increase. In addition, the creation tools to fully exploit the system interface object as described herein will spawn other supporting technology, which may be internal to the core technology provider, rather than resident in any supporting technology provider.

This structure allows for the ongoing incorporation of best of breed technology, and provides for the avoidance of any one supporting technology provider having control or dominance of the core technology provider. Moreover, this structure allows a number of embodiments as seen by those who need system-of-systems knowledge management to be long lived. Since system-of-systems knowledge management is an issue measured by decades, the core technology provider should be stable over a length of time longer than the career of an individual, or the life span of a corporation. This structure provides for a number of techniques for participants to be compensated, to provide incentives, and to provide for replacement of participants who are no longer able to meet the needs of core technology provider clients. At the same time, the structure does not mandate the creation of redundant capability. For example, the structure allows for a supporting technology provider (such as the unified modeling language provider) whose main offering in the past has been software tools supported by license income, to develop a services offering via the core technology provider. The core technology provider is likely to need additional partners to address some customers.

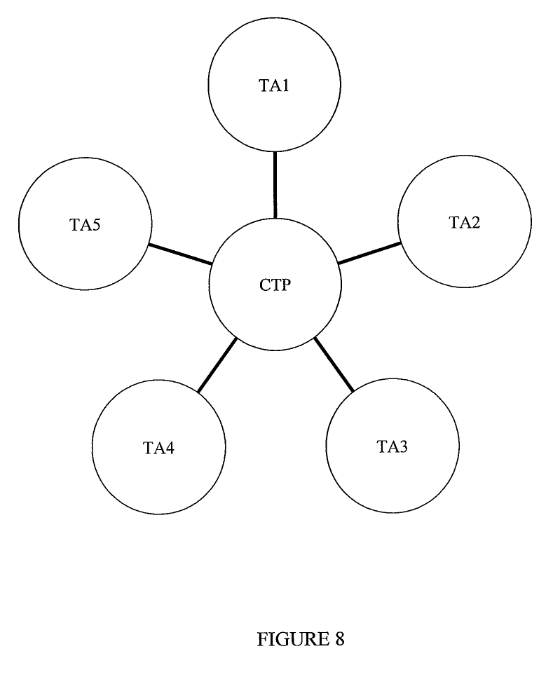

Turning now to FIG. 8, illustrated is a diagram that demonstrates how a core technology provider (designated “CTP”) works with a trusted advisor (designated “TA”) to serve various system-of-systems users in accordance with the principles of the present invention. The first trusted advisor TA1 is for the U.K. Ministry of Defence (“MOD”), the second trusted advisor TA2 is for the U.S. intelligence community, the third trusted advisor TA3 is for the U.S. Department of Defense, the fourth trusted advisor TA4 is for a national telephone operator in a nation, and the fifth trusted advisor TA5 is for a national telephone operator in another nation. Note that in the case of national telephone operators, a trusted advisor is necessary in some cases, while in others, an internal organization within the national telephone operator may allow the core technology provider to do business directly with the national telephone operator.

The aforementioned models provide for a number of income streams to the core technology provider. First, there is income for providing archival services. These services include encapsulation of legacy objects to create new system interface objects such as working with vendors who sell new system elements to system-of-systems operators. In the case of new system elements, the core technology provider might be paid directly by the operator, or by the vendor. The vendor in some cases would work with the core technology provider and, in other cases, might volunteer as part of an open interface, or plug-and-play business strategy.

Second, there is income for providing the assured archiving of system interface objects. Third, there is income for the creation of new system interface objects from the library (archives) of existing system interface objects. Fourth, there is income from the support of the trusted advisors. Fifth, there is license income for tool solutions by the system-of-systems operators, and by their trusted advisors. These are only examples of some of the income streams, and those familiar with such businesses will see that other examples could be cited. The details of these other income streams are dependent on the business practices of the industry vertical.

In the case of government customers, the government may pay the core technology provider and trusted advisor to ensure that system interface objects are available for diffusion across a supplier base, such as the U.S. Federal Aviation Administration or the U.S. Department of Defense. In the case of intelligence organizations (who prize compartmentalization), a trusted advisor may be paid to provide new system interface objects to integrate systems from vendors who do not have access to the system-of-systems they are supporting. In this case, the core technology provider is supported indirectly if only by license revenues, should the direct services be something only the trusted advisor can provide. In other cases, the trusted advisor may have a knowledge management relationship and tools that predate the creation of the core technology provider. Here, the core technology provider may expect that the trusted advisor would integrate system interface objects with the existing business model and solutions.

The challenges in owning and operating complex system-of-systems has been described. These challenges are very expensive and very difficult to overcome. The system interface objects described herein are useful in addressing system-of-systems needs. The teachings in the language of modeling and object oriented design have been set forth such that the teachings will be understood by those skilled in the art, and to illustrate the practicality of extending the usefulness of system interface objects well beyond their original intended use and, therefore, making the system interface objects useful both for the purposes of archiving, and for the purposes of creating new system-of-systems.

Additionally, exemplary embodiments of the present invention have been illustrated with reference to specific components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of system-of-systems. Those skilled in the art will recognize that other embodiments of the invention can be incorporated into a SOSKM system that operates on the principle of tools and methodologies to define the attributes of the system interface objects so as to provide loose coupling between systems and subsystems of a system-of-systems.

Although the present invention has been described in detail, those skilled in the art should understand that they can make various changes, substitutions and alterations herein without departing from the spirit and scope of the invention in its broadest form. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system-of-systems knowledge management (SOSKM) system employable with a system-of-systems, comprising:
an interface object module configured to create system interface objects from a plurality of disparate objects, thereby providing a loose coupling between systems of said system-of-systems; and
a wrapper module configured to encapsulate said system interface objects into a unified modeling language employable to manage said system-of-systems.

2. The SOSKM system as recited in claim 1 further comprising a hardware module configured to provide a hardware model of said system-of-systems as one of said plurality of disparate objects to said interface object module.

3. The SOSKM system as recited in claim 1 further comprising a software module configured to provide a software model of said system-of-systems as one of said plurality of disparate objects to said interface object module.

4. The SOSKM system as recited in claim 1 further comprising a database configured to provide a database object of said system-of-systems as one of said plurality of disparate objects to said interface object module.

5. The SOSKM system as recited in claim 1 further comprising a database configured to archive said system interface objects.

6. The SOSKM system as recited in claim 1 further comprising a modeling module configured to provide process models of processes operating within said system-of-systems as one of said plurality of disparate objects to said interface object module.

7. The SOSKM system as recited in claim 1 wherein said wrapper module is configured to generate test vectors to perform integrity checks in accordance with said system interface objects.

8. The SOSKM system as recited in claim 1 wherein one of said system interface objects is produced by modifying another one of said system interface objects.

9. The SOSKM system as recited in claim 1 wherein said interface object module is configured to provide cohesion between said systems of said system-of-systems.

10. The SOSKM system as recited in claim 1 wherein ones of said system interface objects are provided in accordance with modules from ones of core technology providers, supporting technology providers and trusted advisors.

11. A method of operating a system-of-systems knowledge management (SOSKM) system employable with a system-of-systems, comprising:
creating system interface objects from a plurality of disparate objects, thereby providing a loose coupling between systems of said system-of-systems; and
encapsulating said system interface objects into a unified modeling language employable to manage said system-of-systems.

12. The method as recited in claim 11 further comprising providing a hardware model of said system-of-systems as one of said plurality of disparate objects for creating said system interface objects.

13. The method as recited in claim 11 further comprising providing a software model of said system-of-systems as one of said plurality of disparate objects for creating said system interface objects.

14. The method as recited in claim 11 further comprising providing a database object of said system-of-systems as one of said plurality of disparate objects for creating said system interface objects.

15. The method as recited in claim 11 further comprising archiving said system interface objects.

16. The method as recited in claim 11 further comprising providing process models of processes operating within said system-of-systems as one of said plurality of disparate objects for creating said system interface objects.

17. The method as recited in claim 11 further comprising generating test vectors to perform integrity checks in accordance with said system interface objects.

18. The method as recited in claim 11 wherein one of said system interface objects is produced by modifying another one of said system interface objects.

19. The method as recited in claim 11 further comprising providing cohesion between said systems of said system-of-systems when creating said system interface objects.

20. The method as recited in claim 11 wherein ones of said system interface objects are provided in accordance with core technology providers, supporting technology providers and trusted advisors.
